(19) United States
(12) Patent Application Publication
(10) Pub. No.: US 2024/0311622 A1
(43) Pub. Date: Sep. 19, 2024

(54) SELECTABLE DATA-AWARE ACTIVATION FUNCTIONS IN NEURAL NETWORKS

(71) Applicant: QUALCOMM Incorporated, San Diego, CA (US)

(72) Inventors: Mustafa KESKIN, San Diego, CA (US); Fatih Murat PORIKLI, San Diego, CA (US)

(21) Appl. No.: 18/185,489

(22) Filed: Mar. 17, 2023

(51) Int. Cl. G06N 3/048

(52) U.S. Cl. CPC G06N 3/048

(57) ABSTRACT

Certain aspects of the present disclosure provide techniques and apparatus for operating a neural network using one or more selectable activation functions. The method generally includes generating an intermediate output of a neural network for an input into the neural network. One or more activation functions to apply to the intermediate output are selected. An output of the neural network is generated based on the selected one or more activation functions and the intermediate output, and one or more actions are taken based on the generated output.

### INTRODUCTION

Aspects of the present disclosure relate to neural networks, and more specifically to activation functions used to generate outputs of a neural network.

Neural networks, such as convolutional neural networks, transformer neural networks, and the like, are used to generate inferences from a given input. These neural networks generally include a plurality of neurons which may be connected to other neurons. The outputs of a neuron may be combined into an intermediate output, then modified by an activation function to generate an output of the neural network. Generally, an input, represented as one or more features, may be modified by corresponding weights associated with each neuron in the neural network. These weighted inputs may be aggregated and modified by a bias term in order to generate the intermediate output. The activation function generally performs a nonlinear transformation on the intermediate output in order to transfer knowledge from the input provided to the neural network, the weights, and the bias term.

Generally, neural networks use a predefined activation function in order to generate an output for a given input into the neural network. For example, in neural networks used for binary classification tasks (e.g., determining whether an input is or is not within a specific category), the activation function used in the neural network may be a sigmoid function that maps the intermediate output to a value between 0 and 1 (representing the two choices which can be generated for a binary classification task). In another example, the tanh (hyperbolic tangent) function can be used in a neural network to introduce a nonlinearity such that the output of the neural network is restricted to the range of −1 through 1. Other activation functions, such as a sigmoid function, variants of a rectified linear unit (ReLU), variants of an exponential linear unit, or the like, can be used based on the desired output of the neural network, the computational complexity of tasks performed by the neural network, the device(s) on which the neural network is to be deployed, and the like. However, while a single predefined activation function may be appropriate for many scenarios in which the neural network is used, the single predefined activation function may not produce accurate inference results in certain scenarios.

### BRIEF SUMMARY

Certain aspects of the present disclosure provide a method for operating a neural network using one or more selectable activation functions. The method generally includes generating an intermediate output of a neural network for an input into the neural network. One or more activation functions to apply to the intermediate output are selected. An output of the neural network is generated based on the selected one or more activation functions and the intermediate output, and one or more actions are taken based on the generated output.

Certain aspects of the present disclosure provide a method for training a neural network including one or more selectable activation functions. The method generally includes training a neural network having a plurality of activation functions to apply to at least portions of an intermediate output generated by one or more layers of the neural network. Generally, the neural network includes a selector configured to select at least one activation function of the plurality of activation functions to apply to the intermediate output. The trained neural network is deployed.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict only certain aspects of this disclosure and are therefore not to be considered limiting of the scope of this disclosure.

FIG. 1 illustrates an example neural network including a single activation function.

FIG. 2 illustrates an example neural network including a selectable activation function, according to aspects of the present disclosure.

FIG. 3 illustrates an example neural network including selectable activation functions selected based on statistical measurements associated with an intermediate output of the neural network, according to aspects of the present disclosure.

FIG. 4 illustrates an example neural network including selectable activation functions for different portions of an intermediate output of the neural network, according to aspects of the present disclosure.

FIG. 5 illustrates an example neural network including selectable activation functions based on an input of the neural network, according to aspects of the present disclosure.

FIG. 6 illustrates an example neural network including selectable activation functions based on weights of the neural network, according to aspects of the present disclosure.

FIG. 7 illustrates example operations for generating an output of a neural network using one or more selected activation functions from a plurality of activation functions, according to aspects of the present disclosure.

FIG. 8 illustrates example operations for training a neural network including selectable activation functions, according to aspects of the present disclosure.

FIG. 9 depicts an example processing system configured to perform various aspects of the present disclosure.

FIG. 10 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatus, methods, processing systems, and computer-readable mediums for training and using neural networks including selectable activation functions.

Generally, neural networks use activation functions in order to modify intermediate outputs of the neural network for various purposes. For example, these activation functions can be used to constrain the range of an output of the neural network (e.g., constraining an output between 0 and 1 when the neural network is trained to perform a binary classification, constraining an output between other defined upper and lower bounds to manage the computational complexity of the network, etc.) or to apply other nonlinearities to the intermediate outputs of the neural network. Neural networks may generally be structured to use a single activation function in order to generate an output of the neural network from an input (which may be a set of input features that the neural network uses to generate an output), weights applied to the input, and a bias term. The selection of the single activation function may be based, for example, on the environment in which the neural network is used, the computational capabilities of the devices on which the neural network is deployed, and the like. However, the use of a single activation function may not provide sufficient inference performance in some scenarios. For example, outputs generated by a single activation function may provide sufficient inference performance (e.g., inference accuracy) when an input is in a set of expected inputs for the neural network, but may not provide sufficient inference performance when an input is an outlier (e.g., a rarely seen input).

However, as computing capabilities (e.g., the number of operations per second that can be performed by a processor) on devices on which neural networks are deployed increase, neural networks need not be limited to the use of a single activation function. Aspects of the present disclosure leverage the computational capabilities of the devices on which neural networks are deployed to allow for the selection of one or more activation functions from a plurality of activation functions to apply to intermediate outputs generated by a neural network (e.g., by a layer in a neural network). By allowing for the selection of one or more activation functions to apply to intermediate outputs generated by a neural network, aspects of the present disclosure may allow for the use of activation functions that are appropriate for different ranges of values of intermediate outputs generated by the neural network. The outputs generated by the neural network (e.g., the post-activation version of the intermediate outputs) may thus be tailored to specific scenarios associated with the inputs from which the outputs are generated, which may result in improvements in inference accuracy for the neural network, reductions in processing time used to generate inferences using the neural network and correct incorrect inferences, and the like.

### Introduction to Neural Networks

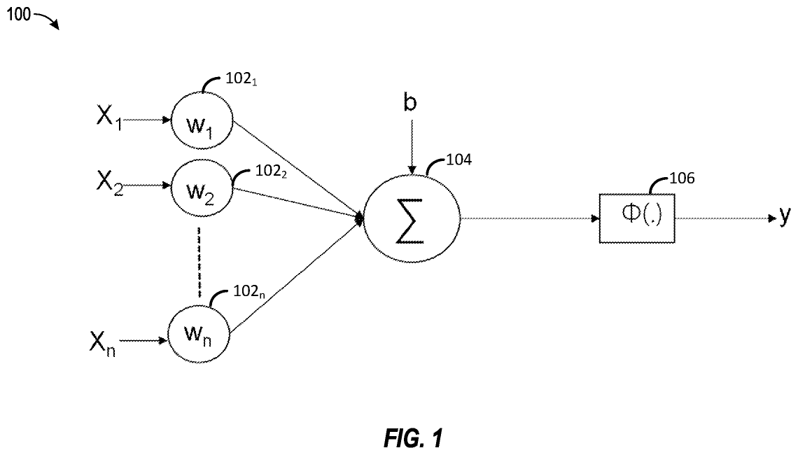

FIG. 1 illustrates an example neural network 100 including a single activation function. As illustrated, neural network 100 includes a plurality of input weighting nodes 102, a weighted-input combining block 104, and an activation block 106.

Neural network 100 generally receives an input x for which an output y is to be generated. The input x includes, or can be used to generate, a set of features x₁, x₂, . . . , xₙ which may be processed using the respective input weighting nodes 102₁-102ₙ. Generally, an input weighting node 102 applies a weight to an input to generate a product xᵢ*wᵢi∈n for each of the n features associated with the input x.

Weighted-input combining block 104 aggregates the outputs of input weighting nodes 102 and applies a bias term b to the aggregated weighted inputs, thus generating an intermediate output for neural network 100. While weighted-input combining block 104 is illustrated as aggregating the weighted inputs (e.g., the outputs of input weighting nodes 102₁-102ₙ) as a sum of the weighted inputs, it should be recognized by one of ordinary skill in the art that any other aggregation or combining technique may be used to combine the weighted inputs into an aggregated weighted input. Generally, weighted-input combining block 104 may generate an output according to the expression:

$${\sum }_{i = 1}^{n} {x}_{i} * {w}_{i} + b$$

Activation block 106 then applies a predefined activation function Φ(⋅) to the intermediate output generated by weighted-input combining block 104. As discussed, the activation function Φ(⋅) may be defined a priori based on various considerations, such as the application for which neural network 100 is to be used (e.g., binary classification, non-binary classification, object detection, prediction, etc.), the computational complexity of the activation function, and the like. The output of activation block 106 may be the output y of the neural network, represented by the equation:

$$y = Φ ( {\sum }_{i = 1}^{n} {x}_{i} * {w}_{i} + b )$$

### Example Selectable Activation Functions in Neural Networks

As discussed, however, the use of a single activation function (e.g., as illustrated by neural network 100 in FIG. 1) to generate output y may not result in sufficient inference performance for a neural network and/or may not efficiently use the computational resources of the devices on which a neural network is deployed. Thus, to improve inference performance and exploit the computational resources of the devices on which a neural network is deployed, aspects of the present disclosure provide for the selection of one or more activation functions to apply to an intermediate output of a neural network. As discussed in further detail herein, the selection of an activation function may be based on a variety of metrics, such as a value of the intermediate output, values of portions of the intermediate output, statistical measurements related to the intermediate output, or the like.

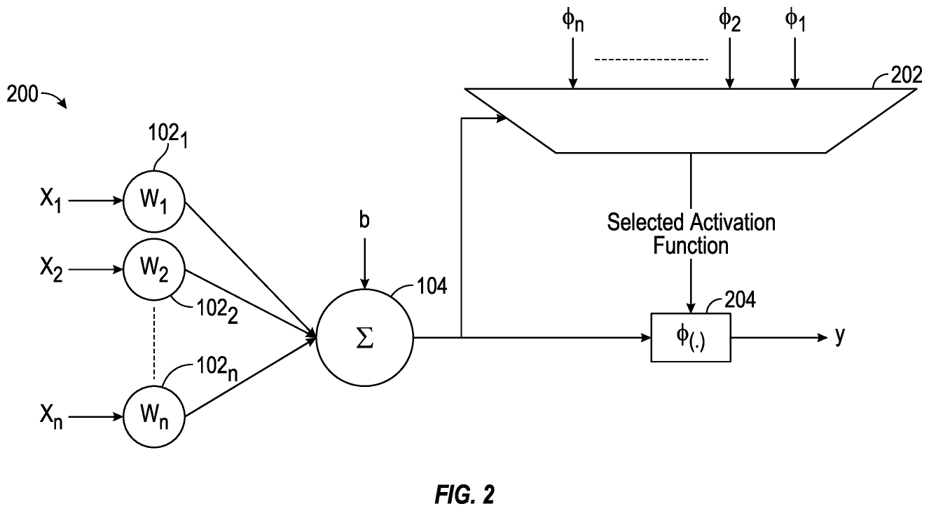

FIG. 2 illustrates example neural network 200 including a selectable activation function, according to aspects of the present disclosure. As with neural network 100 illustrated in FIG. 1, neural network 200 includes a plurality of input weighting nodes 102 and a weighted-input combining block 104. The input weighting nodes 102 may apply a weight value to an input value to generate a weighted input. Generally, for a number n of input features, there may be n input weighting nodes 102, with an i^{th} input weighting node 102 being used to apply an i^{th} weight to an i^{th} input feature. The n weighted input values, generated by the input weighting nodes 102, may be combined (e.g., using a summation function, a multiplication function, a concatenation function, etc.) at weighted-input combining block 104 into an intermediate output of neural network 200.

To generate the post-activation version of the intermediate output, as illustrated, the intermediate output may be input into a selector 202. Selector 202 may be, for example, an n-to-1 multiplexer in which the intermediate output serves as the select input, an indicator of each of the n activation functions supported by neural network 200 serves as the inputs from which selector 202 chooses, and the output of selector 202 corresponds to an indication of the selected activation function. In some aspects, each of the n activation functions may be associated with a range of values for the intermediate output. For example, a first activation function Φ₁ may be selected when the intermediate output is between a defined range of values between a and b, a second activation function Φ₂ may be selected when the intermediate output is between a defined range of values between a value that is greater than b and c, and so on. For example, Φ₁ may correspond to a rectified linear unit activation function; Φ₂ may correspond to a softmax activation function, and so on (though, it should be understood that any variety of activation functions may be defined as candidate activation functions for selection through selector 202). It should be noted that the largest value associated with the selection of one activation function and the smallest value associated with the selection of a different activation function need not be contiguous; that is, the value of b and the value greater than b need not be adjacent to each other.

Activation block 204 uses the indication of the selected activation function received from selector 202 and the intermediate output generated by weighted-input combining block 104 to generate an output of the neural network 200.

Because neural network 200 allows for the selection of different activation functions for different ranges of values, neural network 200 may provide for the application of multiple types of nonlinearities to an intermediate output that is responsive to the underlying data used to generate these intermediate outputs (also referred to as being “data-aware”). That is, instead of restricting the nonlinearity applied to an intermediate output to a specific type of nonlinearity provided by a specific activation function, the nonlinearity applied to an intermediate output by neural network 200 may differ based on the value of the intermediate output.

For example, assume that neural network 200 is configured to allow for a binary choice between the hyperbolic tangent (tanh) activation function and the rectified linear unit (ReLU) activation function, where the tanh function is applicable to values of the intermediate output that are less than 0 and the ReLU function is applicable to values of the intermediate output that are greater than 0. In this example, the activation function may thus have a range of output values between −1 and ∞, with outputs of the activation function between −1 and 0 being the result of applying the tanh activation function to intermediate outputs having a value less than 0 and outputs of the activation function greater than 0 being the result of applying the ReLU function to intermediate outputs having a value greater than 0. In another example, where the ReLU function is applicable to values of the intermediate output less than 0 and the tanh function is applicable to values of the intermediate output greater than 0, the activation function may have a range of output values between 0 and 1, where intermediate outputs having a value less than 0 have a post-activation output of 0 and intermediate outputs having a value greater than 1 have a post-activation output between 0 and 1, with the post-activation output asymptotically approaching 1 as the value of the intermediate output approaches ∞.

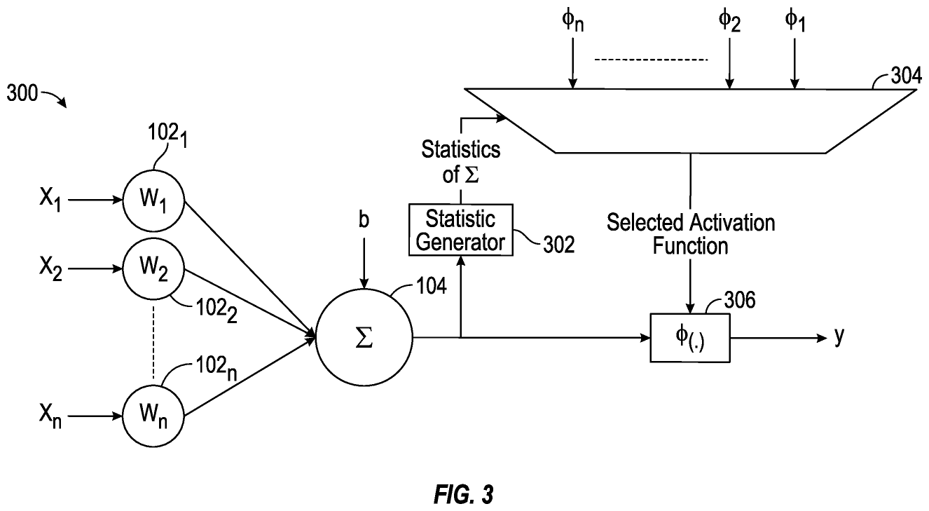

FIG. 3 illustrates an example neural network 300 including selectable activation functions selected based on statistical measurements associated with an intermediate output of the neural network, according to aspects of the present disclosure.

In neural network 300 illustrated in FIG. 3, statistical measurements related to the intermediate output are used to select an activation function to apply to the intermediate output generated by weighted-input combining block 104.

Statistic generator 302 receives the intermediate output in order to generate various statistical measurements related to the intermediate output. Generally, statistic generator 302 may generate these statistical measurements based on historical data, such as prior intermediate outputs generated for inputs processed by neural network 300, intermediate outputs generated during training and/or validation of neural network 300, and the like. These statistical measurements may include, for example, a mean and standard deviation against which the intermediate output generated by weighted-input combining block 104 is compared. In such an example, the output of statistic generator 302 may be a number of standard deviations from the mean that the intermediate output of neural network 300 is at.

Selector 304, similarly to selector 202 illustrated in FIG. 2, may be an n-to-1 multiplexer. However, unlike selector 202, which takes the value of the intermediate output as the selector value itself, selector 304 uses the statistical measurements generated by statistic generator 302 as the selector input based on which one or more activation functions are to be selected. Each activation function of the n activation functions may be associated with a different range of statistical measurements. For example, a first activation function may be associated with values within one standard deviation from the mean, a second activation function may be associated with values between one and two standard deviations from the mean, a third activation function may be associated with values between two and three standard deviations from the mean, and so on. While the foregoing discusses units of standard deviation as an example, it should be recognized that other statistical measurements, such as variance measurements, quartile statistics, data distribution statistics, auto-correlation, or the like, can be used, with difference ranges of these statistical measurements being associated with different activation functions.

Activation block 306 uses the indication of the selected activation function received from selector 304 and the intermediate output generated by weighted-input combining block 104 to generate an output of the neural network 300.

In this example, neural network 300, like neural network 200, applies different nonlinearities to different values of an intermediate output. However, unlike neural network 200, in which a priori defined split points are used to define when different activation functions are applied to an intermediate output, neural network 300 applies different activation functions on a statistical basis. As additional inputs are processed through neural network 300, neural network 300 may adjust the selection of activation functions to use in processing an intermediate output based on updated historical distributions of inputs (and corresponding intermediate outputs). Thus, neural network 300 may perform data-distribution-aware activation of intermediate outputs generated within neural network 300.

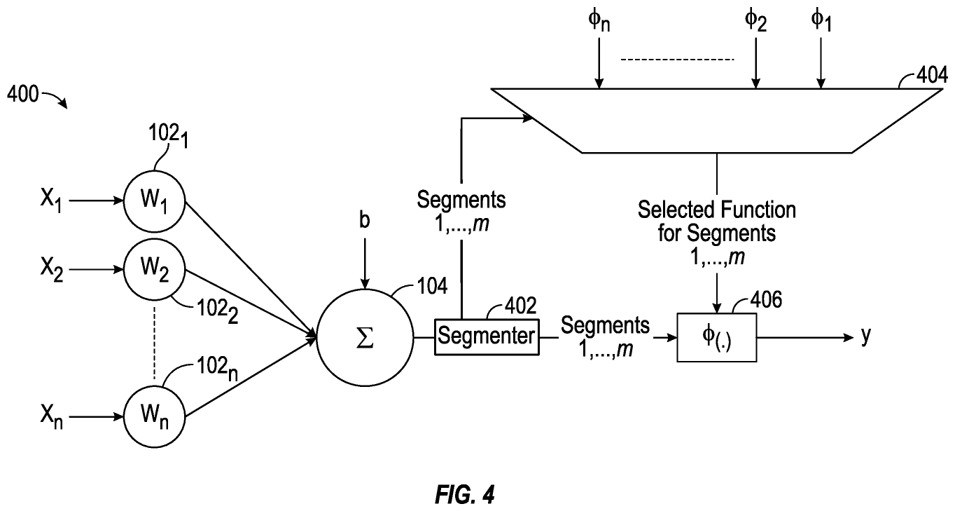

In some aspects, different segments of an intermediate output may be processed using different activation functions. For example, an intermediate output may be divided into some number of most significant bits (MSBs) and a remaining number of least significant bits (LSBs), or otherwise divided into a plurality of segments which may be independently processed using different activation functions. FIG. 4 illustrates an example neural network 400 including selectable activation functions for different portions of an intermediate output of the neural network 400, according to aspects of the present disclosure.

As illustrated, neural network 400 includes a segmenter 402 that segments the intermediate output generated by weighted-input combining block 104 into m>1 segments. For example, in a binary split, segmenter 402 may be configured to divide the intermediate output into an MSB portion and an LSB portion. The MSB portion and the LSB portion may be the same number of bits or may be different, and the number of bits included in the MSB portion and the LSB portion may be defined a priori. In one example, for an intermediate output generated as a 32-bit integer, the MSB portion may be the most significant (top) 16 bits of the intermediate output and the LSB portion may be the least significant (bottom) 16 bits of the intermediate output. In another example, for an intermediate output generated as a floating point number (e.g., formatted according to the IEEE 754 standard), the intermediate output may be divided into the base, precision, and exponent portions of the floating point number. Of course, it should be recognized that these are only examples of how an intermediate output may be segmented into a plurality of segments, and any variety of segmentation schemes, or a combination thereof, may be used to generate a plurality of segments from the intermediate output for processing using independently selected activation functions.

In some aspects, segmenter 402 can additionally or alternatively use various statistical parameters to segment the intermediate output into m>1 segments. For example, segmenter 402 can segment the intermediate output based on quartile statistics, with different types of segmentation being associated with data in different quartiles of a distribution, different types of data distributions (e.g., a Gaussian distribution, a uniform distribution, or the like), auto-correlation with other inputs, or other statistical measurements.

Selector block 404 generally is configured to select an activation function to apply to each of the m segments into which segmenter 402 divides an intermediate output. While selector block 404 is illustrated in FIG. 4 as a single multiplexer that uses the values of the m segments as selector inputs, it should be recognized that neural network 400 may include m selector blocks 404, each of which may be dedicated to selecting an activation function for a corresponding segment of the intermediate output. That is, the i^{th} selector block 404 may be configured to select an activation function to apply to the i^{th} segment of the intermediate output, where i∈m.

Activation block 406 generally uses the segments of the intermediate output generated by segmenter 402 and the identification of the selection function for each segment of the intermediate output to generate the output y of neural network 400. To generate the output y of neural network 400, activation block 406 can generate a segmented activation output yᵢ=Φ(x*w+b)ᵢ), i∈m for each segment of the intermediate output. The segmented activation outputs may be aggregated into a single output using various techniques, such as summation, concatenation, or the like, and the aggregated output y may be output as the output of neural network 400.

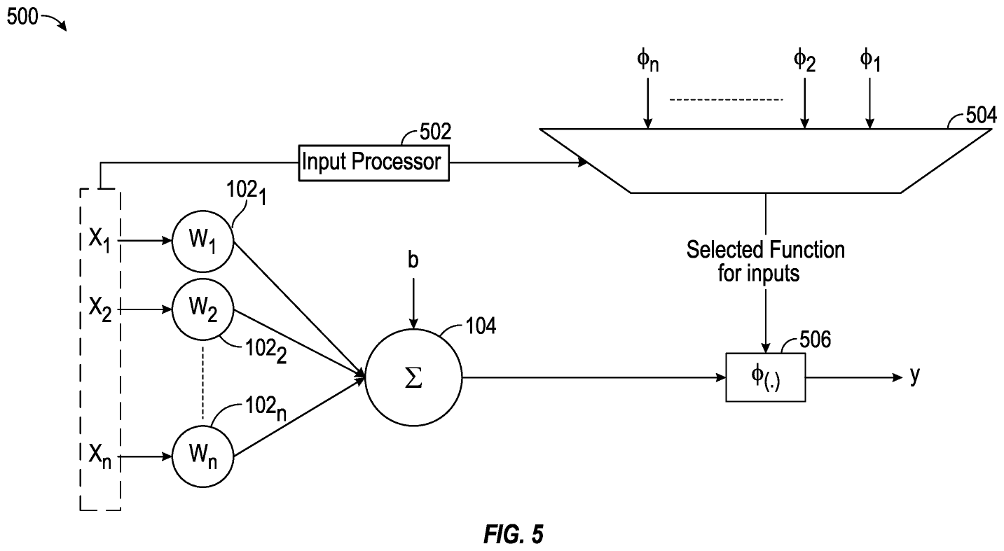

In some aspects, activation functions to be used in generating an output of a neural network may be based on information related to inputs or weights in the neural network. Using information related to inputs or weights in the neural network may accelerate processing of an input through the neural network. FIG. 5 illustrates an example neural network 500 including selectable activation functions based on an input of the neural network, according to aspects of the present disclosure. As illustrated, to select one or more activation functions for use in generating an output y of neural network 500 from an input x, input x may be processed at input processor 502. Generally, input processor 502 may be configured to perform various operations with respect to input x, such as segmenting input x into a plurality of segments or generating various statistical measurements related to the input x.

For example, in aspects in which input processor 502 segments input x into a plurality of segments, input processor 502 can segment the input x by dividing input x into some number of most significant bits (MSBs) and a remaining number of least significant bits (LSBs). In another example, input processor 502 can segment an input x into a plurality of segments which may be independently processed using different activation functions. For example, input x may be segmented into groups of features, and each group of features may be processed using a selectable activation function.

In some aspects, input processor 502 can generate statistical measurements related to an input x which selector 504 can use to select one or more activation functions to use in generating an output y for input x. Generally, input processor 502 may generate these statistical measurements based on historical data, such as prior inputs processed by neural network 500, inputs used to train and/or validate neural network 500, and the like. These statistical measurements may include, for example, a mean and standard deviation against which input x is compared. In such an example, the output of input processor 502 may be a number of standard deviations from the mean of the input into neural network 500.

Selector 504 uses the information generated by input processor 502 to select one or more activation functions to apply to the intermediate output (e.g., generated by weighted-input combining block 104 and, in some aspects, segmented based on a segmentation of inputs performed by input processor 502). The selected activation function(s) may be indicated to activation block 506, which may apply the selected activation function(s) to the intermediate output generated by weighted-input combining block 104 to generate output y.

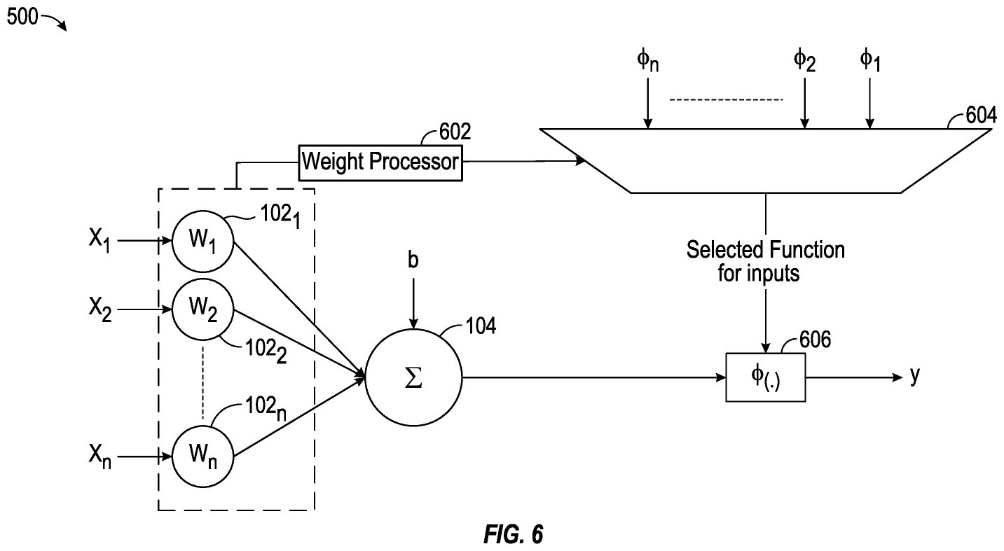

FIG. 6 illustrates an example neural network 600 including selectable activation functions based on weights of the neural network, according to aspects of the present disclosure. As illustrated, to select one or more activation functions for use in generating an output y of neural network 600 from an input x, the weights w used by neural network 600 may be processed at weight processor 602. Generally, weight processor 602 may be configured to perform various operations with respect to weights w, such as segmenting weights w into a plurality of segments or generating various statistical measurements related to the weights w. Weight processor 602 may function similarly to input processor 502 illustrated in FIG. 5, using the weights w as inputs for statistical measurement or segmentation instead of the input x to neural network 600. Generally, weight processor 602 can output data related to the weights w in neural network 600 to selector 604, which selects one or more activation functions to apply to the intermediate output generated by weighted-input combining block 104 based on the information related to the weights in neural network 600 generated by weight processor 602. Activation block 606 uses the activation functions selected by selector 604 to process the intermediate output generated by weighted-input combining block 104 and generate output y of neural network 600.

In some aspects, selector blocks 404, 504, and 604 may be implemented as lookup tables in an effort to minimize the computational expense involved in selecting and applying activation functions to intermediate outputs in neural networks 400, 500, and 600, respectively. In such a case, the activation functions supported by the neural network may be fixed such that a post-activation value for a segment of an input may be calculated a priori and keyed to an input value for that segment of the input. In such a case, the outputs of the selector blocks 404, 504, 604 may be combined at activation blocks 406, 506, and 606 to generate the output of neural networks 400, 500, 600, respectively.

In some aspects, segmentation of inputs and/or weights illustrated in neural networks 400, 500, and 600 may be selectively performed. For example, neural networks 400, 500, and 600 may segment inputs in some data domains while leaving other inputs unsegmented for processing by the neural networks. Segmentation of domain-specific data may be performed, for example, based on a priori defined data domains for which segmentation may provide for improved inference accuracy, reductions in computational expense, or the like.

It should be understood that aspects of neural networks 200, 300, 400, 500, and 600 may be combined. For example, the segmentation aspects of neural network 400 may be combined with the range-based selection of activation functions of neural network 200. In this case, the activation function for each respective segment of an intermediate output may be selected based on ranges of values of the respective segment of the intermediate output. In another example, the segmentation aspects of neural network 400 may be combined with the statistical measurement-based selection of activation functions of neural network 300. In this example, the activation function for each respective segment of the intermediate output may be selected based on statistical measurements (e.g., the number of standard deviations from the mean) associated with the respective segment of the intermediate output.

In some aspects, to train any of neural networks 200, 300, or 400, training may be performed by backpropagating activation outputs selected for application to the intermediate output (or portion thereof). In some aspects, various statistics related to intermediate outputs generated by the neural networks 200, 300, or 400 can be measured in order to determine both what activation functions are to be applied to an intermediate output and whether to backpropagate specific intermediate outputs through the neural network. For example, intermediate outputs that are outliers (e.g., more than a threshold number of standard deviations away from the mean value of an intermediate output) may not be backpropagated through the neural network. In another example, intermediate outputs that are outliers in a particular direction (e.g., some number of standard deviations above the mean or some number of standard deviations below the mean) may not be backpropagated through the neural network, while other intermediate outputs (e.g., that are outliers in the opposite direction) may be backpropagated through the neural network.

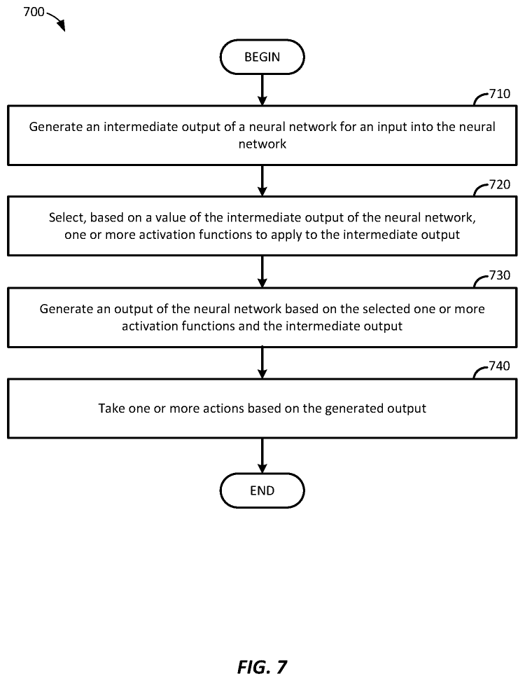

FIG. 7 illustrates example operations 700 for generating an output of a neural network using one or more selected activation functions from a plurality of activation functions, according to aspects of the present disclosure. Operations 700 may be performed by a device on which a neural network (such as neural networks 200, 300, 400, 500, or 600 illustrated in FIGS. 2-6) is deployed in order to generate inferences from inputs provided to the device. For example, operations 700 may be performed by a smartphone, a laptop computer, a desktop computer, a server computer, one or more compute devices in an autonomous vehicle, one or more computing devices that autonomously control another device, or the like.

As illustrated, operations 700 begin at block 710 with generating an intermediate output of a neural network for an input into the neural network. As discussed, an input may include or be decomposed into a set of n features (e.g., as a one-dimensional vector of n features, a multidimensional feature map including n features distributed across the dimensions of the feature map, or the like). To generate the intermediate output, each of the n input features may be modified based on a corresponding weight value, and the weighted input features may be aggregated and modified based on a bias term. In one example, the intermediate output of the neural network may be represented as the sum of the individual weighted inputs, modified by a bias term, according to the expression:

$${\sum }_{i = 1}^{n} ( {x}_{i} * {w}_{i} ) + b$$

where xᵢ represents the i^{th} input feature, wᵢ represents the weight applied to the i^{th} feature, and b represents a bias term.

At block 720, operations 700 proceed with selecting one or more activation functions to apply to the intermediate output.

In some aspects, the one or more activation functions to apply to the intermediate output are selected based on a value of the intermediate output of the neural network.

In some aspects, each activation function of the one or more activation functions is associated with a range of values for the intermediate output. For example, a first activation function may be associated with a range of values between a and b, a second activation function may be associated with a range of values between b and c, and so on. In another example, where the choice of an activation function is a binary choice, a first activation function may be associated with values for the intermediate output less than a threshold value, and a second activation function may be associated with values for the intermediate output greater than the threshold value. To select the one or more activation functions to apply to the intermediate output, the activation function associated with the range of values in which the value of the intermediate output lies may be selected.

In some aspects, the one or more activation functions to apply to the intermediate output are selected based on one or more statistical measurements associated with the intermediate output.

In some aspects, the one or more statistical measurements may be related to a probability density function describing probabilities associated with different values for the intermediate output.

In some aspects, the one or more statistical measurements may include a mean and standard deviation measurement relative to a distribution of possible values for the intermediate output. In some examples, a first activation function may be selected for application to the intermediate output when the value of the intermediate output is within a threshold number of standard deviations from the mean. Meanwhile, a second activation function may be selected for application to the intermediate output when the value of the intermediate output is more than the threshold number of standard deviations from the mean. In other examples, a plurality of activation functions may be defined, with each activation function of the plurality of activation functions being associated with a range of standard deviations from the mean. The selected activation function may thus be the activation function associated with the range of standard deviations from the mean in which the intermediate output lies.

In some aspects, the one or more activation functions to apply to the intermediate output may be based on a value of the input to the neural network. The input may be segmented into a plurality of segments, with each segment of the input being independently processed using a selectable activation function selected based on a value of that segment of the input. In some aspects, statistical measurements related to the input may be used to select the one or more activation functions to use in processing the intermediate output.

In some aspects, the one or more activation functions to apply to the intermediate output may be based on values of weights in the neural network. The weights may be segmented, with each segment of weights corresponding to a segment of an intermediate output which may be processed independently using an activation function selected based on a value of a weight associated with the segment of the intermediate output. In some aspects, statistical measurements related to values of the weights in the neural network may be used to select the one or more activation functions to use in processing the intermediate output.

In some aspects, selecting the one or more activation functions to apply to the intermediate output includes searching for a post-activation value of the intermediate output in a lookup table based on a value of the intermediate output. The lookup table may include a plurality of entries associated with possible (valid) values of an intermediate output. Each value for an intermediate output may be mapped to a post-activation value, representing the selection of an activation function to apply to the intermediate output (or segment thereof).

At block 730, operations 700 proceed with generating an output of the neural network based on the selected one or more activation functions and the intermediate output.

In some aspects, selecting the one or more activation functions to apply to the intermediate output includes segmenting the intermediate output into a plurality of segments. For each respective segment of the plurality of segments, a respective activation function may be selected for application to the respective segment. For example, the selection of an activation function for each segment of the intermediate output may be based on ranges of values associated with each segment of the intermediate output, where each activation function is associated with different ranges of values for each segment of the intermediate output. In other examples, the selection of an activation function for each segment of the intermediate output may be based on statistical measurements (e.g., a number of standard deviations from the mean) associated with the intermediate output, where each activation function is associated with different statistical measurements (or ranges of statistical measurements) for each segment of the intermediate output.

In some aspects, to generate the output for the neural network when the intermediate output is segmented into a plurality of segments, segment-specific activation outputs may be generated based on a value of each respective segment of the plurality of segments and the selected respective activation function for the respective segment. The segment-specific activation outputs may be concatenated into a combined output. In some aspects, concatenating the segment-specific activation outputs may include generating a bitstream in which a first set of bits correspond to the activation output for a first segment of the intermediate output, a second set of bits (following the first set of bits) correspond to the activation output for a second segment of the intermediate output, and so on. For example, in a scenario in which the intermediate output is segmented into a set of high bits (e.g., an MSB portion associated with bits above a split point) and a set of low bits (e.g., an LSB portion associated with bits below the split point), the output for the neural network may be generated as a bitstream including the activation output for the set of high bits, followed by the activation output for the set of low bits. In other examples, the segment-specific activation outputs may be combined mathematically (e.g., via summation, multiplication, etc.).

At block 740, operations 700 proceed with taking one or more actions based on the generated output.

Generally, the one or more actions taken based on the generated output may be based on the application for which the neural network is trained. For example, for a neural network trained to perform data compression, the one or more actions may include selecting a level of compression to be applied to portions of the input, with more lossy compression being selected for portions of the input that the generated output of the neural network identifies as being less important and less-lossy (or lossless) compression being selected for portions of the input that the generated output of the neural network identifies as being more important. In another example, for a neural network trained for object detection in autonomous environments (e.g., in controlling autonomous vehicles, robot arms operating in constrained environments, or the like), the generated output may indicate the presence of objects within the path of travel for a device operating in these autonomous environments. Thus, the generated output may be used to control how the device moves within the environment, such as by identifying a path and/or velocity of travel and generating the appropriate control signals to instruct the device to move according to the identified path and/or velocity of travel.

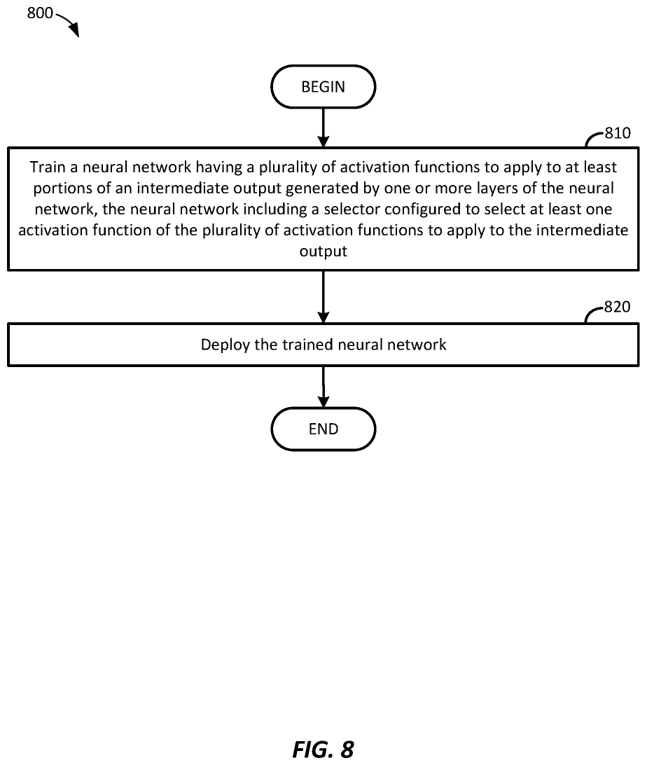

FIG. 8 illustrates example operations 800 for training a neural network including selectable activation functions, according to aspects of the present disclosure. Operations 800 may be performed, for example, by a computing device on which neural networks may be trained, such as server computers, clusters of computing devices, devices participating in a federated learning scheme in which local data from multiple computing devices is used to train a neural network, or the like.

As illustrated, operations 800 begin at block 810 with training a neural network having a plurality of activation functions to apply to at least portions of an intermediate output generated by one or more layers of the neural network. Generally, the neural network includes a selector configured to select at least one activation function of the plurality of activation functions to apply to the intermediate output.

In some aspects, each activation function of the plurality of activation functions is associated with a range of values for the intermediate output. The selector is generally configured to select an activation function associated with a range of values in which the value of the intermediate output lies from the plurality of activation functions.

In some aspects, the selector is generally configured to select the at least one activation function to apply to the intermediate output based on a partitioning of the intermediate output into a plurality of segments. Each segment of the plurality of segments is generally processed using a different activation function from the plurality of activation functions.

In some aspects, the selector is configured to select the at least one activation function to apply to the intermediate output based on one or more statistical measurements associated with the intermediate output.

In some aspects, training the neural network includes generating one or more statistical measurements associated with the intermediate output. The at least one activation function is selected based on the generated one or more statistical measurements. A result of applying the selected at least one activation function to the intermediate output is backpropagated through at least a portion of the neural network.

At block 820, operations 800 proceed with deploying the trained neural network.

### Example Processing Systems for Selectable Activation Functions in Neural Networks

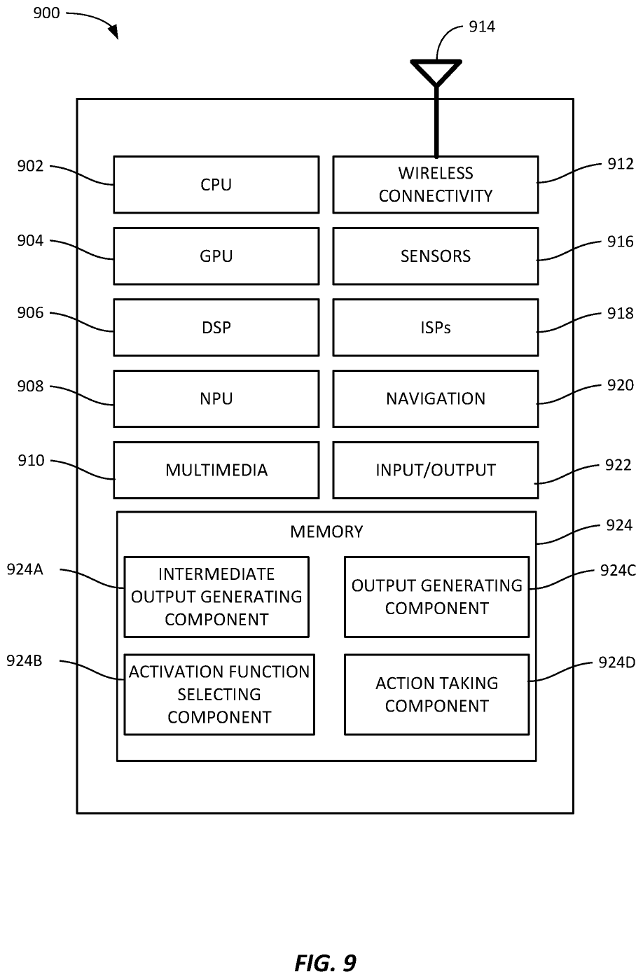

FIG. 9 depicts an example processing system 900 for generating an output of a neural network using one or more selected activation functions from a plurality of activation functions, such as described herein for example with respect to FIG. 7.

Processing system 900 includes a central processing unit (CPU) 902, which in some examples may be a multi-core CPU. Instructions executed at the CPU 902 may be loaded, for example, from a program memory associated with the CPU 902 or may be loaded from a memory partition (e.g., of memory 924).

Processing system 900 also includes additional processing components tailored to specific functions, such as a graphics processing unit (GPU) 904, a digital signal processor (DSP) 906, a neural processing unit (NPU) 908, and a connectivity component 912.

An NPU, such as NPU 908, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as NPU 908, are configured to accelerate the performance of common machine learning tasks, such as image classification, machine translation, object detection, and various other predictive models. In some examples, a plurality of NPUs may be instantiated on a single chip, such as a system on a chip (SoC), while in other examples such NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new piece through an already trained model to generate a model output (e.g., an inference).

In one implementation, NPU 908 is a part of one or more of CPU 902, GPU 904, and/or DSP 906. These may be located on a UE or another computing device.

In some examples, connectivity component 912 may include subcomponents, for example, for third generation (3G) connectivity, fourth generation (4G) connectivity (e.g., LTE), fifth generation (5G) connectivity (e.g., NR), Wi-Fi connectivity, Bluetooth connectivity, and other wireless data transmission standards. Connectivity component 912 may be further coupled to one or more antennas (not shown).

In some examples, one or more of the processors of processing system 900 may be based on an ARM or RISC-V instruction set.

Processing system 900 also includes memory 924, which is representative of one or more static and/or dynamic memories, such as a dynamic random access memory, a flash-based static memory, and the like. In this example, memory 924 includes computer-executable components, which may be executed by one or more of the aforementioned processors of processing system 900.

In particular, in this example, memory 924 includes intermediate output generating component 924A, activation function selecting component 924B, output generating component 924C, and action taking component 924D. The depicted components, and others not depicted, may be configured to perform various aspects of the methods described herein.

Generally, processing system 900 and/or components thereof may be configured to perform the methods described herein.

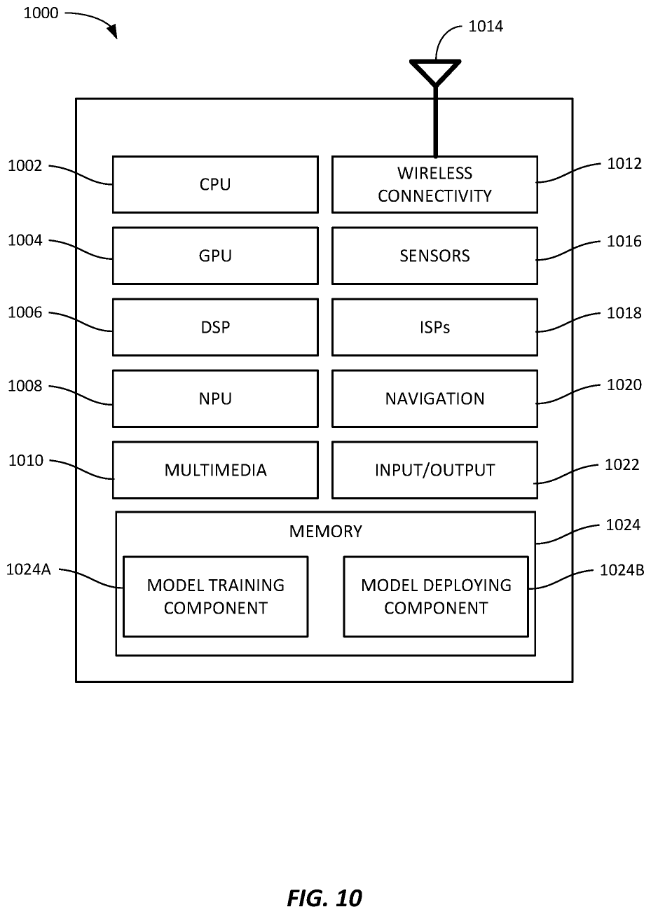

FIG. 10 depicts an example processing system 1000 for training a machine learning model having selectable activation functions, such as described herein for example with respect to FIG. 8.

Processing system 1000 includes a central processing unit (CPU) 1002 and may include additional processing components tailored to specific functions, such as a graphics processing unit (GPU) 1004, a digital signal processor (DSP) 1006, a neural processing unit (NPU) 1008, a multimedia processing unit 1010, and a wireless connectivity component 1012. CPU 1002, GPU 1004, DSP 1006, and NPU 1008 may be similar to CPU 902, GPU 904, DSP 906, and NPU 908 discussed above with respect to FIG. 9.

In some examples, wireless connectivity component 1012 may include subcomponents, for example, for third generation (3G) connectivity, fourth generation (4G) connectivity (e.g., LTE), fifth generation (5G) connectivity (e.g., NR), Wi-Fi connectivity, Bluetooth connectivity, and other wireless data transmission standards. Wireless connectivity component 1012 is further coupled to one or more antennas 1014.

Processing system 1000 may also include one or more sensor processing units 1016 associated with any manner of sensor, one or more image signal processors (ISPs) 1018 associated with any manner of image sensor, and/or a navigation processor 1020, which may include satellite-based positioning system components (e.g., GPS or GLONASS) as well as inertial positioning system components.

Processing system 1000 may also include one or more input and/or output devices 1022, such as screens, touch-sensitive surfaces (including touch-sensitive displays), physical buttons, speakers, microphones, and the like.

In some examples, one or more of the processors of processing system 1000 may be based on an ARM or RISC-V instruction set.

Processing system 1000 also includes memory 1024, which is representative of one or more static and/or dynamic memories, such as a dynamic random access memory, a flash-based static memory, and the like. In this example, memory 1024 includes computer-executable components, which may be executed by one or more of the aforementioned processors of processing system 1000.

In particular, in this example, memory 1024 includes model training component 1024A and model deploying component 1024B. The depicted components, and others not depicted, may be configured to perform various aspects of the methods described herein.

Generally, processing system 1000 and/or components thereof may be configured to perform the methods described herein.

Notably, in other aspects, features of processing system 1000 may be omitted, such as where processing system 1000 is a server computer or the like. For example, multimedia processing unit 1010, wireless connectivity component 1012, sensor processing units 1016, ISPs 1018, and/or navigation processor 1020 may be omitted in other aspects. Further, aspects of processing system 1000 may be distributed, such as training a model and using the model to generate inferences, such as user verification predictions.

### EXAMPLE CLAUSES

Implementation examples are described in the following numbered clauses:

Clause 1: A processor-implemented method, comprising: generating an intermediate output of a neural network for an input into the neural network; selecting one or more activation functions to apply to the intermediate output; generating an output of the neural network based on the selected one or more activation functions and the intermediate output; and taking one or more actions based on the generated output.

Clause 2: The method of Clause 1, wherein: each activation function of the one or more activation functions is associated with a range of values for the intermediate output; and selecting the one or more activation functions to apply to the intermediate output comprises selecting an activation function associated with the range of values in which the value of the intermediate output lies.

Clause 3: The method of Clause 1 or 2, wherein selecting the one or more activation functions to apply to the intermediate output comprises: segmenting the intermediate output into a plurality of segments; and for each respective segment of the plurality of segments, selecting a respective activation function to apply to the respective segment.

Clause 4: The method of Clause 3, wherein generating the output of the neural network comprises: generating segment-specific activation outputs based on a value of each respective segment of the plurality of segments and the selected respective activation function for the respective segment; and concatenating the segment-specific activation outputs into a combined output.

Clause 5: The method of Clause 3 or 4, wherein segmenting the intermediate output into the plurality of segments comprises segmenting the intermediate output into a high segment and a low segment, the high segment corresponding to bits of the intermediate output having a position above a split point and the low segment corresponding to bits of the intermediate output having a position below the split point.

Clause 6: The method of any of Clauses 1 through 5, wherein the one or more activation functions to apply to the intermediate output are selected based on one or more statistical measurements associated with the intermediate output.

Clause 7: The method of Clause 6, wherein the one or more statistical measurements comprise a mean and standard deviation measurement relative to a distribution of possible values for the intermediate output.

Clause 8: The method of Clause 7, wherein selecting the one or more activation functions comprises: selecting a first activation function when the value of the intermediate output is within a threshold number of standard deviations from the mean, and selecting a second activation function when the value is more than the threshold number of standard deviations from the mean.

Clause 9: The method of any of Clauses 6 through 8, wherein the one or more statistical measurements are related to a probability density function describing probabilities associated with different values for the intermediate output.

Clause 10: The method of any of Clauses 1 through 9, wherein selecting the one or more activation functions to apply to the intermediate output is based, at least in part, on the input into the neural network.

Clause 11: The method of any of Clauses 1 through 10, wherein selecting the one or more activation functions to apply to the intermediate output is based, at least in part, on weights in the neural network.

Clause 12: The method of any of Clauses 1 through 11, wherein selecting the one or more activation functions to apply to the intermediate output comprises searching for a post-activation value of the intermediate output in a lookup table based on a value of the intermediate output.

Clause 13: A computer-implemented method, comprising: training a neural network having a plurality of activation functions to apply to at least portions of an intermediate output generated by one or more layers of the neural network, the neural network including a selector configured to select at least one activation function of the plurality of activation functions to apply to the intermediate output; and deploying the trained neural network.

Clause 14: The method of Clause 13, wherein: each activation function of the plurality of activation functions is associated with a range of values for the intermediate output; and the selector is configured to select an activation function associated with a range of values in which the value of the intermediate output lies from the plurality of activation functions.

Clause 15: The method of Clause 13 or 14, wherein the selector is configured to select the at least one activation function to apply to the intermediate output based on a partitioning of the intermediate output into a plurality of segments, and wherein each segment of the plurality of segments is processed using a different activation function from the plurality of activation functions.

Clause 16: The method of any of Clauses 13 through 15, wherein the selector is configured to select the at least one activation function to apply to the intermediate output based on one or more statistical measurements associated with the intermediate output.

Clause 17: The method of any of Clauses 13 through 16, wherein training the neural network comprises: generating one or more statistical measurements associated with the intermediate output; selecting the at least one activation function based on the generated one or more statistical measurements; and backpropagating a result of applying the selected at least one activation function to the intermediate output through at least a portion of the neural network.

Clause 18: A system, comprising: a memory having executable instructions stored thereon; and a processor configured to execute the executable instructions in order to cause the system to perform the operations of any of Clauses 1 through 17.

Clause 19: A system comprising means for performing the operations of any of Clauses 1 through 17.

Clause 20: A computer-readable medium having instructions stored thereon which, when executed by a processor, perform the operations of any of Clauses 1 through 17.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processor-implemented method, comprising:
generating an intermediate output of a neural network for an input into the neural network;
selecting one or more activation functions to apply to the intermediate output;
generating an output of the neural network based on the selected one or more activation functions and the intermediate output; and
taking one or more actions based on the generated output.

2. The method of claim 1, wherein:
each activation function of the one or more activation functions is associated with a range of values for the intermediate output; and
selecting the one or more activation functions to apply to the intermediate output comprises selecting an activation function associated with the range of values in which the value of the intermediate output lies.

3. The method of claim 1, wherein selecting the one or more activation functions to apply to the intermediate output comprises:
segmenting the intermediate output into a plurality of segments; and
for each respective segment of the plurality of segments, selecting a respective activation function to apply to the respective segment.

4. The method of claim 3, wherein generating the output of the neural network comprises:
generating segment-specific activation outputs based on a value of each respective segment of the plurality of segments and the selected respective activation function for the respective segment; and
concatenating the segment-specific activation outputs into a combined output.

5. The method of claim 3, wherein segmenting the intermediate output into the plurality of segments comprises segmenting the intermediate output into a high segment and a low segment, the high segment corresponding to bits of the intermediate output having a position above a split point and the low segment corresponding to bits of the intermediate output having a position below the split point.

6. The method of claim 1, wherein the one or more activation functions to apply to the intermediate output are selected based on one or more statistical measurements associated with the intermediate output.

7. The method of claim 6, wherein the one or more statistical measurements comprise a mean and standard deviation relative to a distribution of possible values for the intermediate output.

8. The method of claim 7, wherein selecting the one or more activation functions comprises:
selecting a first activation function when the value of the intermediate output is within a threshold number of standard deviations from the mean, and
selecting a second activation function when the value is more than the threshold number of standard deviations from the mean.

9. The method of claim 6, wherein the one or more statistical measurements are related to a probability density function describing probabilities associated with different values for the intermediate output.

10. The method of claim 1, wherein selecting the one or more activation functions to apply to the intermediate output is based, at least in part, on the input into the neural network.

11. The method of claim 1, wherein selecting the one or more activation functions to apply to the intermediate output is based, at least in part, on weights in the neural network.

12. The method of claim 1, wherein selecting the one or more activation functions to apply to the intermediate output comprises searching for a post-activation value of the intermediate output in a lookup table based on a value of the intermediate output.

13. A processor-implemented method, comprising:
training a neural network having a plurality of activation functions to apply to at least portions of an intermediate output generated by one or more layers of the neural network, the neural network including a selector configured to select at least one activation function of the plurality of activation functions to apply to the intermediate output; and
deploying the trained neural network.

14. The method of claim 13, wherein:
each activation function of the plurality of activation functions is associated with a range of values for the intermediate output; and
the selector is configured to select an activation function associated with a range of values in which the value of the intermediate output lies from the plurality of activation functions.

15. The method of claim 13, wherein the selector is configured to select the at least one activation function to apply to the intermediate output based on a partitioning of the intermediate output into a plurality of segments, and wherein each segment of the plurality of segments is processed using a different activation function from the plurality of activation functions.

16. The method of claim 13, wherein the selector is configured to select the at least one activation function to apply to the intermediate output based on one or more statistical measurements associated with the intermediate output.

17. The method of claim 13, wherein training the neural network comprises:
generating one or more statistical measurements associated with the intermediate output;
selecting the at least one activation function based on the generated one or more statistical measurements; and
backpropagating a result of applying the selected at least one activation function to the intermediate output through at least a portion of the neural network.

18. A system, comprising:
a memory having executable instructions stored thereon; and
a processor configured to execute the executable instructions in order to cause the system to:
generate an intermediate output of a neural network for an input into the neural network;
select one or more activation functions to apply to the intermediate output;
generate an output of the neural network based on the selected one or more activation functions and the intermediate output; and
take one or more actions based on the generated output.

19. The system of claim 18, wherein:
each activation function of the one or more activation functions is associated with a range of values for the intermediate output; and
in order to select the one or more activation functions to apply to the intermediate output, the processor is configured to cause the system to select an activation function associated with the range of values in which the value of the intermediate output lies.

20. The system of claim 18, wherein in order to select the one or more activation functions to apply to the intermediate output, the processor is configured to cause the system to:
segment the intermediate output into a plurality of segments; and
for each respective segment of the plurality of segments, select a respective activation function to apply to the respective segment.

21. The system of claim 20, wherein in order to generate the output of the neural network, the processor is configured to cause the system to:
generate segment-specific activation outputs based on a value of each respective segment of the plurality of segments and the selected respective activation function for the respective segment; and
concatenate the segment-specific activation outputs into a combined output.

22. The system of claim 20, wherein in order to segment the intermediate output into the plurality of segments, the processor is configured to cause the system to segment the intermediate output into a high segment and a low segment, the high segment corresponding to bits of the intermediate output having a position above a split point and the low segment corresponding to bits of the intermediate output having a position below the split point.

23. The system of claim 18, wherein the one or more activation functions to apply to the intermediate output are selected based on one or more statistical measurements associated with the intermediate output.

24. The system of claim 23, wherein the one or more statistical measurements comprise a mean and standard deviation relative to a distribution of possible values for the intermediate output.

25. The system of claim 24, wherein in order to select the one or more activation functions, the processor is configured to cause the system to:
select a first activation function when the value of the intermediate output is within a threshold number of standard deviations from the mean, and
select a second activation function when the value is more than the threshold number of standard deviations from the mean.

26. The system of claim 23, wherein the one or more statistical measurements are related to a probability density function describing probabilities associated with different values for the intermediate output.

27. The system of claim 18, wherein in order to select the one or more activation functions to apply to the intermediate output, the processor is configured to cause the system to select the one or more activation functions based, at least in part, on the input into the neural network.

28. The system of claim 18, wherein in order to select the one or more activation functions to apply to the intermediate output, the processor is configured to cause the system to select the one or more activation functions based, at least in part, on weights in the neural network.

29. The system of claim 18, wherein in order to select the one or more activation functions to apply to the intermediate output, the processor is configured to cause the system to search for a post-activation value of the intermediate output in a lookup table based on a value of the intermediate output.

30. A system, comprising:
a memory having executable instructions stored thereon; and
a processor configured to execute the executable instructions in order to cause the system to:
train a neural network having a plurality of activation functions to apply to at least portions of an intermediate output generated by one or more layers of the neural network, the neural network including a selector configured to select at least one activation function of the plurality of activation functions to apply to the intermediate output; and
deploy the trained neural network.
